(19) United States
(12) Patent Application Publication
(10) Pub. No.: US 2023/0272288 A1
(43) Pub. Date: Aug. 31, 2023

(54) CO-PROCESSING ROUTE FOR HYDROTREATING POLYMER WASTE-BASED MATERIAL

(71) Applicant: Neste Oyj, Espoo (FI)

(72) Inventors: Pekka AALTO, Porvoo (FI); Kari JANSSON, Porvoo (FI); Ville PAASIKALLIO, Porvoo (FI); Andrea PÉREZ NEBREDA, Porvoo (FI); Emma SAIRANEN, Porvoo (FI)

(73) Assignee: Neste Oyj, Espoo (FI)

(21) Appl. No.: 18/312,898

(22) Filed: May 5, 2023

Related U.S. Application Data
(63) Continuation of application No. 18/000,758, filed on Dec. 5, 2022.

(30) Foreign Application Priority Data
Dec. 30, 2020 (FI) 20206383

(51) Int. Cl. C10G 1/10; C10G 45/08; C10G 7/00; C10G 67/04; C10G 1/00

(52) U.S. Cl. CPC C10G 1/10; C10G 45/08; C10G 7/00; C10G 67/04; C10G 1/002; C10G 2400/08; C10G 2300/1003; C10G 2300/301; C10G 2300/4025; C10G 2300/107

(57) ABSTRACT

Provided is a method for upgrading polymer waste-based material. The method includes providing a polymer waste-based feedstock, providing a crude oil-derived feedstock, mixing the polymer waste-based feedstock, the crude oil-derived feedstock, and optionally a further feed material, to provide a feed mixture, hydrotreating the feed mixture in a FCC feed hydrotreater to provide a hydrocarbonaceous material, and recovering at least a distillate product and a distillation bottoms product from the hydrocarbonaceous material (step E).

### TECHNICAL FIELD

The present invention generally relates to a route for co-processing polymer waste-based material with fossil material, and specifically relates to a route employing a hydroprocessing process under FCC feed hydrotreater conditions, and to products obtained in this procedure.

### BACKGROUND OF THE INVENTION

The purification of polymer waste, such as liquefied waste plastics (LWP), to yield more valuable (pure) substances and the conversion of polymer waste into more valuable material have been studied for several years. Polymer waste refers to waste material comprising polymers, such as plastic waste, end-life tires, and liquid polymer materials. In practice, polymer waste is usually processed in the form of polymer waste-based oils (also referred to as liquefied polymer waste), such as liquefied waste plastics (LWP) or liquefied end-life tires.

Polymer waste-based oils may be produced by a thermal degradation method, such as hydrothermal liquefaction (HTL) or pyrolysis of polymer waste. Depending on the source of the polymer waste, polymer waste has variable levels of impurities. Typical impurity components are chlorine, nitrogen, sulphur and oxygen of which corrosive chlorine is particularly problematic for refinery/petrochemical processes. These impurities are also common in post-consumer waste plastics (recycled consumer plastics) that has been identified as a potential large scale source for polymer waste besides end-life tires. Similarly, bromine-containing impurities may be contained mainly in industry-derived polymer waste (e.g. originating from flame retardants). Moreover, polymer waste-based oils which are produced by a pyrolysis process or hydrothermal liquefaction usually contain significant amounts of olefins and aromatics, depending on the actual production process, each of which may lead to problems in some downstream processes, such as polymerisation (or coking) at elevated temperatures.

No matter whether the polymer waste-based material is merely subjected to common refinery processing (e.g. fractionation) or is forwarded to a typical petrochemical conversion process (e.g. steam cracking), the polymer waste-based material needs to meet the impurity levels for these processes so as to avoid deterioration of the facility, such as corrosion of reactors or catalyst poisoning.

In addition to refining, chemical recycling of polymer waste back to polymers (or to monomers) is an interesting option. This option has caught significant interest in the petrochemical industry during the last years. The interest has been further boosted by new waste directive and the EU plastic strategy that both set ambitious targets for the recycling of waste plastics (polymer waste).

It can thus be expected that chemical recycling will be an important method to recycle polymer waste back to polymers (plastic) and chemicals in the future.

Using polymer waste-based material as feedstock for crackers (such as catalytic crackers, hydrocrackers or steam crackers) is also a promising method to recycle polymers because of the existing infrastructure. However, the potential of polymer waste-based material as cracker feedstock depends on its quality and thus methods for purifying the polymer waste-based material and/or modifying the cracking procedures have been proposed in order to handle the varying impurity contents of polymer waste.

WO 2018/10443 A1 discloses a steam cracking process comprising pre-treatment of a mainly paraffinic hydrocarbon feed, such as hydrowax, hydrotreated vacuum gas oil, pyrolysis oil from waste plastics, gasoil or slackwax. Pre-treatment is carried out using a solvent extraction so as to reduce fouling components, such as polycyclic aromatics and resins.

US 2016/0264874 A1 discloses a process for upgrading waste plastics, comprising a pyrolysis step, a hydroprocessing step, a polishing step and a stream cracking step in this order.

Kawanishi, T., Shiratori, N., Wakao, H., Sugiyama, E., Ibe, H., Shioya, M., & Abe, T., “Upgrading of Light Thermal Cracking Oil Derived from Waste Plastics in Oil Refinery. Feedstock recycling of plastics.” Universitätsverlag Karlsruhe, Karlsruhe (2005), p. 43-50 discloses hydrotreating a blend of petroleum fractions and light thermal cracking oil from waste plastics to avoid fouling of a heat exchanger preceding the hydrotreater.

### SUMMARY OF INVENTION

The above prior art approaches employ complicated purification procedures, of which extraction techniques may result in significant amounts of contaminated extraction material, or provide a material which is still not fully suitable for subsequent processing and leads to fouling and reduced service life of the processing equipment. There is still need for a more sustainable process allowing recycling varying amounts of polymer waste-based material while producing low amounts of waste products.

The present invention was made in view of the above-mentioned problems and it is an object of the present invention to provide an improved method for upgrading polymer waste-based material, in particular a more flexible method allowing recycling varying amounts and/or types of polymer waste-based material with high efficiency.

This problem of providing an improved method for upgrading polymer waste-based material is solved by a method of claim 1.

In brief, the present invention relates to one or more of the following items:
1. A method for upgrading polymer waste-based material, the method comprising:
   providing a polymer waste-based feedstock (step A),
   providing a crude oil-derived feedstock (step B),
   mixing the polymer waste-based feedstock, the crude oil-derived feedstock, and optionally a further feed material, to provide a feed mixture (step C),
   hydrotreating the feed mixture in a FCC feed hydrotreater to provide a hydrocarbonaceous material (step D), and
   recovering at least a distillate product and a distillation bottoms product from the hydrocarbonaceous material (step E).
2. The method according to item 1, wherein the crude oil-derived feedstock comprises a FCC feedstock.
3. The method according to item 1 or 2, wherein the crude oil-derived feedstock comprises at least one crude oil-fraction selected from a vacuum gas oil (VGO) fraction, a gas oil (GO) fraction, a heavy gas oil (HGO) fraction, a kerosene fraction, a light gas oil fraction, an atmospheric residue (AR) fraction, a vacuum residue (VR) fraction, and a deasphalted oil (DAO) fraction, preferably at least one crude oil-fraction selected from a vacuum gas oil (VGO) fraction, a heavy gas oil (HGO) fraction, an atmospheric residue (AR) fraction, a vacuum residue (VR) fraction and a deasphalted oil (DAO) fraction.
4. The method according to any one of the preceding items, wherein at least 40 wt.-% of the crude oil-derived feedstock boil at a temperature of 370° C. or above (40% distillation temperature according to ASTM-D2887).
5. The method according to any one of the preceding items, wherein at least 45 wt.-% of the crude oil-derived feedstock boil at a temperature of 370° C. or above, preferably at least 50 wt.-%, at least 55 wt.-%, at least 60 wt.-% or at least 65 wt.-%.
6. The method according to any one of the preceding items, wherein the crude oil-derived feedstock has a 5% boiling point (according to ASTM-D2887) of at least 160° C., preferably at least 170° C., at least 180° C., at least 190° C., or at least 200° C.
7. The method according to any one of the preceding items, wherein the crude oil-derived feedstock has a 95% boiling point (according to ASTM-D2887) of 630° C. or lower, preferably 610° C. or lower, 590° C. or lower, 570° C. or lower, or 560° C. or lower.
8. The method according to any one of the preceding items, wherein the crude oil-derived feedstock has a final boiling point (according to ASTM-D2887) of 650° C. or lower, preferably 630° C. or lower, 620° C. or lower, 610° C. or lower, or 600° C. or lower.
9. The method according to any one of the preceding items, wherein, in step E, at least a heavy gas oil (HGO) fraction is recovered, and the heavy gas oil fraction has a 10% boiling point (according to ASTM-D2887) of at least 300° C., preferably at least 310° C., at least 320° C., at least 330° C., at least 340° C., at least 345° C., at least 350° C., or at least 355° C.
10. The method according to any one of the preceding items, wherein the yield of a heavy fraction boiling at 350° C. or above obtained in step D is at least 50 wt.-%, when calculated as the ratio (m_{H}/m_{liq}) between mass of obtained heavy fraction (m_{H}) and total mass of liquid hydrocarbonaceous products (m_{liq}), preferably at least 55 wt.-%, at least 60 wt.-%, or at least 65 wt.-%.
11. The method according to any one of the preceding items, wherein the yield of a light hydrocarbonaceous fraction boiling at 150° C. or below obtained in step D is at most 10.0 wt.-%, when calculated as the ratio (m_{L}/mₕₜ) between mass of obtained light hydrocarbonaceous fraction (m_{L}) and total mass of hydrocarbonaceous products (mₕₜ), preferably at most 8.0 wt.-%, at most 6.0 wt.-%, at most 5.0 wt.-%, at most 4.0 wt.-%, at most 3.0 wt.-%, or at most 2.0 wt.-%.
12. The method according to any one of the preceding items, wherein the FCC feed hydrotreater operates at a temperature in the range of from 300-460° C.
13. The method according to any one of the preceding items, wherein the FCC feed hydrotreater operates at a temperature of 320° C. or above, preferably 340° C. or above or 360° C. or above.
14. The method according to any one of the preceding items, wherein the FCC feed hydrotreater operates at a temperature of 455° C. or below, preferably 450° C. or below, 445° C. or below, 440° C. or below, 435° C. or below, 430° C. or below, 425° C. or below, 420° C. or below, 415° C. or below, or 410° C. or below.
15. The method according to any one of the preceding items, wherein the FCC feed hydrotreater operates at a hydrogen partial pressure of at least 10 bar, preferably at least 20 bar, at least 25 bar, at least 30 bar, at least 33 bar, at least 35 bar, at least 38 bar, or at least 40 bar.
16. The method according to any one of the preceding items, wherein the FCC feed hydrotreater operates at a hydrogen partial pressure of at most 100 bar, preferably at most 90 bar, at most 80 bar, at most 70 bar, at most 60 bar, at most 55 bar, or at most 50 bar.
17. The method according to any one of the preceding items, wherein the FCC feed hydrotreater operates at a liquid hourly space velocity (LHSV, m³ liquid feed per m³ catalyst per hour) of at most 8.0 h⁻¹, preferably at most 6.0 h⁻¹, at most 4.0 h⁻¹, at most 3.0 h⁻¹, at most 2.0 h⁻¹, at most 1.5 h⁻¹, or at most 1.3 h⁻¹.
18. The method according to any one of the preceding items, wherein the FCC feed hydrotreater operates at a liquid hourly space velocity (LHSV) of at least 0.2 h⁻¹, preferably at least 0.4 h⁻¹, at least 0.6 h⁻¹, at least 0.7 h⁻¹, at least 0.8 h⁻¹, at least 0.9 h⁻¹, or at least 1.0 h⁻¹.
19. The method according to any one of the preceding items, wherein the FCC feed hydrotreater operates at a ratio (H2/HC) between hydrogen (H2) and feed mixture (HC) of at most 800 l/l, preferably at most 600 l/l, at most 500 l/l, at most 350 l/l, or at most 300 l/l.
20. The method according to any one of the preceding items, wherein the FCC feed hydrotreater operates at a ratio (H2/HC) between hydrogen (H2) and feed mixture (HC) of at least 50 l/l, preferably at least 100 l/l, at least 120 l/l, at least 150 l/l, at least 180 l/l, at least 200 l/l, or at least 220 l/l.
21. The method according to any one of the preceding items, wherein the FCC feed hydrotreater employs a catalyst, preferably a supported catalyst.
22. The method according to any one of the preceding items, wherein the FCC feed hydrotreater employs a catalyst and the catalyst comprises at least one component selected from IUPAC group 6, 8 or 10 of the Periodic Table of Elements.
23. The method according to any one of the preceding items, wherein the FCC feed hydrotreater employs a catalyst and the catalyst is a supported catalyst containing Mo and at least one further transition metal on a support.
24. The method according to any one of the preceding items, wherein the FCC feed hydrotreater employs a catalyst and the catalyst is a supported NiMo catalyst or a supported CoMo catalyst.
25. The method according to any one of the preceding items, wherein the FCC feed hydrotreater employs a catalyst and the catalyst is a supported catalyst, wherein the support comprises alumina and/or silica.
26. The method according to any one of the preceding items, wherein the FCC feed hydrotreater employs a catalyst and the catalyst is a supported NiMo catalyst and the support comprises alumina (NiMo/Al₂O₃).
27. The method according to any one of the preceding items, wherein the FCC feed hydrotreater employs a catalyst and the catalyst is a supported CoMo catalyst and the support comprises alumina (CoMo/Al₂O₃).
28. The method according to any one of the preceding items, wherein the FCC feed hydrotreater works under olefin-saturation conditions.
29. The method according to any one of the preceding items, wherein the FCC feed hydrotreater is adjusted such that the ratio (BRh/BRf) between the bromine number of the hydrocarbonaceous material (BRh) and the bromine number of the feed mixture (BRf) is 0.50 or less, preferably 0.40 or less, 0.30 or less, 0.20 or less, 0.10 or less, 0.07 or less, 0.06 or less 0.05 or less or 0.04 or less.
30. The method according to any one of the preceding items, wherein the method further comprises subjecting at least part of the distillation bottoms product to fluid catalytic cracking (FCC), optionally together with a co-feed (FCC co-feed).
31. The method according to any one of the preceding items, wherein the polymer waste-based feedstock provided in step A is or comprises a polymer waste-based oil or a fraction thereof.
32. The method according to any one of the preceding items, wherein the mixing in step C is carried out such that the feed mixture contains at most 50 wt.-% of the polymer waste-based feedstock, preferably at most 40 wt.-%, at most 30 wt.-% or at most 25 wt.-%.
33. The method according to any one of the preceding items, wherein the mixing in step C is carried out such that the feed mixture contains at least 0.5 wt.-% of the polymer waste-based feedstock, preferably at least 1.0 wt.-%, at least 1.5 wt.-% or at least 2.0 wt.-%.
34. The method according to any one of the preceding items, wherein the mixing in step C is carried out such that the feed mixture contains at least 25 wt.-% of the crude oil-derived feedstock, preferably at least 30 wt.-%, at least 40 wt.-%, at least 50 wt.-%, at least 60 wt.-%, at least 70 wt.-% or at least 75 wt.-%.
35. The method according to any one of the preceding items, wherein the mixing in step C is carried out such that the feed mixture contains at most 99 wt.-% of the crude oil-derived feedstock.
36. The method according to any one of the preceding items, wherein the polymer waste-based feedstock is or comprises a liquefied polymer waste or a fraction thereof, such as liquefied waste plastics (LWP) or a fraction thereof, in particular waste plastics pyrolysis oil (WPPO) or a fraction thereof, or liquefied end-life tires or a fraction thereof, such as end-life tires pyrolysis oil (ELTPO) or a fraction thereof.
37. The method according to any one of the preceding items, wherein the polymer waste-based feedstock is or comprises a pyrolysis oil feedstock derived from pyrolysis of polymer waste, or a fraction thereof, and/or the polymer waste-based feedstock is or comprises a feedstock derived from hydrothermal liquefaction of polymer waste, or a fraction thereof.
38. The method according to any one of the preceding items, wherein the polymer waste-based feedstock is a pyrolysis oil feedstock or a fraction thereof.
39. The method according to any one of the preceding items, wherein the polymer waste-based feedstock is a liquefied and pre-treated material which has been subjected to pre-treatment after liquefaction.
40. The method according to any one of the preceding items, wherein the polymer waste-based feedstock has a chlorine content of 5 wt.-ppm or more.
41. The method according to any one of the preceding items, wherein the polymer waste-based feedstock has a chlorine content of 10 wt.-ppm or more, 15 wt.-ppm or more, 20 wt.-ppm or more, 50 wt.-ppm or more, or 100 wt.-ppm or more.
42. The method according to any one of the preceding items, wherein the polymer waste-based feedstock has a chlorine content of 4000 wt.-ppm or less, 3000 wt.-ppm or less, 2000 wt.-ppm or less, 1000 wt.-ppm or less, 500 wt.-ppm or less, 400 wt.-ppm or less, or 200 wt.-ppm or less.
43. The method according to any one of the preceding items, wherein the polymer waste-based feedstock has an olefins content of 10 wt.-% or more, 15 wt.-% or more, 20 wt.-% or more, 30 wt.-% or more, 40 wt.-% or more, or 50 wt.-% or more.
44. The method according to any one of the preceding items, wherein the polymer waste-based feedstock has an olefins content of 85 wt.-% or less, 80 wt.-% or less, 70 wt.-% or less, or 65 wt.-% or less.
45. The method according to any one of the preceding items, wherein, in step E, at least a heavy gas oil (HGO) fraction is recovered.
46. The method according to item 45, wherein the HGO fraction has an aromatics content of 10 wt.-% or more, 15 wt.-% or more, 20 wt.-% or more, 25 wt.-% or more, 30 wt.-% or more, or 40 wt.-% or more.
47. The method according to item 45 or 46, wherein the HGO fraction has an aromatics content of 85 wt.-% or less, 80 wt.-% or less, 70 wt.-% or less, or 60 wt.-% or less.
48. The method according to any one of items 45 to 47, wherein the HGO fraction has a nitrogen content of 100 wt.-ppm or more, 200 wt.-ppm or more, 300 wt.-ppm or more, 400 wt.-ppm or more, 500 wt.-ppm or more, or 600 wt.-ppm or more.
49. The method according to any one of items 45 to 48, wherein the HGO fraction has a nitrogen content of 5000 wt.-ppm or less, 4000 wt.-ppm or less, 3000 wt.-ppm or less, or 2000 wt.-ppm or less.
50. The method according to any one of items 45 to 49, wherein the HGO fraction has a sulphur content of 10 wt.-ppm or more, 20 wt.-ppm or more, 30 wt.-ppm or more, 50 wt.-ppm or more, 100 wt.-ppm or more, 200 wt.-ppm or more, 250 wt.-ppm or more, 300 wt.-ppm or more, 350 wt.-ppm or more, or 400 wt.-ppm or more.
51. The method according to any one of items 45 to 50, wherein the HGO fraction has a sulphur content of 10000 wt.-ppm or less, 6000 wt.-ppm or less, 5000 wt.-ppm or less, 4000 wt.-ppm or less, or 3000 wt.-ppm or less.
52. The method according to any one of the preceding items, wherein the step A of providing the polymer waste-based feedstock includes a stage of thermal degradation (such as pyrolysis or hydrothermal liquefaction) of polymer waste.
53. The method according to any one of the preceding items, wherein the FCC feed hydrotreater employs a mixed catalyst and the mixed catalyst comprises at least a supported CoMo catalyst and the support comprises alumina (CoMo/Al₂O₃), and the CoMo/Al₂O₃ accounts for at least 60 vol.-% of the total catalyst, more preferably at least 70 vol.-% or at least 80 vol.-%.
54. The method according to item 53, wherein the mixed catalyst further comprises at least a supported NiMo catalyst and the support comprises alumina (NiMo/Al₂O₃).
55. The method according to any one of the preceding items, wherein the FCC feed hydrotreater employs a catalyst and the catalyst is sulphided in its active form, such as a sulphided NiMo catalyst or a sulphided CoMo catalyst.
56. The method according to any one of the preceding items, wherein the FCC feed hydrotreater employs a catalyst and the catalyst comprises a sulphided NiMo catalyst and/or a sulphided CoMo catalyst.
57. The method according to any one of the preceding items, wherein the polymer waste-based feedstock provided in step A is or comprises a non-fractionated polymer waste-based oil.
58. The method according to any one of the preceding items, wherein the distillation bottoms product has an aromatics content of 10 wt.-% or more, 15 wt.-% or more, 20 wt.-% or more, 25 wt.-% or more, 30 wt.-% or more, or 40 wt.-% or more.
59. The method according to any one of the preceding items, wherein the distillation bottoms product has an aromatics content of 85 wt.-% or less, 80 wt.-% or less, 70 wt.-% or less, or 60 wt.-% or less.
60. The method according to any one of the preceding items, wherein the distillation bottoms product has a nitrogen content of 100 wt.-ppm or more, 200 wt.-ppm or more, 300 wt.-ppm or more, 400 wt.-ppm or more, 500 wt.-ppm or more, or 600 wt.-ppm or more.
61. The method according to any one of the preceding items, wherein the distillation bottoms product has a nitrogen content of 5000 wt.-ppm or less, 4000 wt.-ppm or less, 3000 wt.-ppm or less, or 2000 wt.-ppm or less.
62. The method according to any one of the preceding items, wherein the distillation bottoms product has a sulphur content of 10 wt.-ppm or more, 20 wt.-ppm or more, 30 wt.-ppm or more, 50 wt.-ppm or more, 100 wt.-ppm or more, 200 wt.-ppm or more, 250 wt.-ppm or more, 300 wt.-ppm or more, 350 wt.-ppm or more, or 400 wt.-ppm or more.
63. The method according to any one of the preceding items, wherein the distillation bottoms product has a sulphur content of 10000 wt.-ppm or less, 6000 wt.-ppm or less, 5000 wt.-ppm or less, 4000 wt.-ppm or less, or 3000 wt.-ppm or less.
64. The method according to any one of the preceding items, wherein, in step E, at least a heavy gas oil (HGO) fraction is recovered, and the heavy gas oil fraction has a 90% boiling point (according to ASTM-D2887) of 620° C. or lower, preferably 600° C. or lower, 580° C. or lower, 560° C. or lower, or 550° C. or lower.
65. A mixture of hydrocarbons obtainable by the method according to any one of the preceding items.
66. The mixture of hydrocarbons according to items 65 which is a HGO fraction obtained in step E.
67. A hydrocarbonaceous material obtainable in step D of the method according to any one of items 1 to 64.
68. The hydrocarbonaceous material according to item 67, wherein the hydrocarbonaceous material comprises more than 16 wt.-% of a fraction boiling in the range of 150-300° C. and at least 60 wt.-% of a fraction boiling above 370° C.
69. A use of the mixture of hydrocarbons according to item 65 or 66 or of the hydrocarbonaceous material according to item 67 or 68 as a raw material in the production of fuel, such as a diesel component, a gasoline component, a marine fuel component or a jet fuel component, a raw material in the production of chemicals, such as a solvent, and/or a raw material in the production of polymers, such as polypropylene and/or polyethylene.
70. A use of the mixture of hydrocarbons according to item 65 or 66 or a fraction thereof, or of the hydrocarbonaceous material according to item 67 or 68, or a fraction thereof, as a FCC feedstock, or a steam cracking feedstock.

### DETAILED DESCRIPTION OF THE INVENTION

The present invention relates to a method for upgrading polymer waste-based material and more specifically to a co-processing route for hydrotreating polymer waste-based material.

A polymer waste-based feedstock, such as a liquefied product of collected consumer plastics or of tires having reached the end of their service life (end-life tires), contains large and varying amounts of contaminants which would be detrimental in e.g. steam cracking or in other downstream processes such as fluid catalytic cracking (FCC). Such contaminants include, among others, halogens (mainly chlorine) originating from halogenated plastics (such as PVC and PTFE), sulphur originating from cross-linking agents of rubbery polymers (e.g. in end-life tires) and metal or metalloid (e.g. Si, Al) contaminants originating from composite materials and additives (e.g. films coated with metals or metal compounds, end-life tires, or plastics processing aids). These contaminants may be present in elemental form, in ionic form, or as a part of organic or inorganic compounds.

These impurities/contaminants may result in coking and/or other (undesired) side-reactions in conventional oil refinery or petrochemical processes (such as steam cracking or FCC), thus shifting the product distribution to less valuable products or even towards products which have to be disposed (i.e. waste). Similarly, these impurities may have corrosive or otherwise degrading action, thus reducing the service life of the refinery equipment.

The production process of a polymer waste-based material (i.e. a polymer waste-based feedstock) usually comprises at least one kind of thermal degradation, such as pyrolysis or hydrothermal liquefaction or similar process steps to provide polymer waste-based oil(s) as the polymer waste feed. It is intrinsic to these thermal degradation processes that the resulting polymer waste-based oil has a high olefins content. The hydrotreatment step of the present invention reduces the content of olefins in the polymer waste feedstock (and in the co-feed, as the case may be) and thus produces a hydrotreated material (also referred to as hydrocarbonaceous material) having (significantly) reduced content of olefins.

The present invention relate to a method for upgrading polymer waste-based material. The method of the present invention comprises the following steps:
(Step A) providing a polymer waste-based feedstock
(Step B) providing a crude oil-derived feedstock
(Step C) mixing (blending) the polymer waste-based feedstock, the crude oil-derived feedstock, and optionally a further feed material, to provide a feed mixture
(Step D) hydrotreating the feed mixture in a FCC feed hydrotreater to provide a hydrocarbonaceous material
(Step E) recovering at least a distillate product and a distillation bottoms product from the hydrocarbonaceous material.

In the present invention, the term “polymer waste” refers to an organic polymer material which is no longer fit for its use or which has been disposed for any other reason. Polymer waste may specifically be solid and/or liquid polymer material and is (or comprises) usually a solid polymer material. Polymer waste more specifically may refer to end-life tires, collected consumer plastics (consumer plastics referring to any organic polymer material in consumer good, even if not having “plastic” properties as such), collected industrial polymer waste. In the sense of the present invention, the term “polymer waste” or “polymer” in general does not encompass purely inorganic materials (which are otherwise sometimes referred to as inorganic polymers). Polymers in the polymer waste may be of natural and/or synthetic origin and may be based on renewable and/or fossil raw material.

The term “polymer waste-based feedstock” or “polymer waste-based material” refers to a feedstock (or raw material of a process) which is derived from polymer waste. Preferably, “polymer waste-based feedstock” (or “polymer waste-based material”) specifically refers to an oil or an oil-like product obtainable from liquefaction, i.e. non-oxidative thermal or thermocatalytic depolymerisation of (solid) polymer waste (followed by optional subsequent fractionation and/or purification). In other words, the “polymer waste-based feedstock” or “polymer waste-based material” may also be referred to as “depolymerized polymer waste” or “liquefied polymer waste”.

The method of liquefaction is not particularly limited and one may mention pyrolysis (such as fast pyrolysis) of polymer waste, or hydrothermal liquefaction of polymer waste.

The term “hydrothermal liquefaction” (HTL) refers to a thermal depolymerization process to convert a carbon containing feedstock into crude-like oil under moderate temperature and high pressure using subcritical or supercritical water. The term “pyrolysis” refers to thermal decomposition of materials at elevated temperatures in a non-oxidative atmosphere. The term “fast pyrolysis” refers to thermochemical decomposition of carbon containing feedstock through rapid heating in the absence of oxygen.

The term “crude oil-derived feedstock” refers to a material (or stream) which is derived from crude oil. Usually, the crude oil-derived feedstock will be a crude oil fraction, which may be further purified/polished or not. Preferably, a crude oil fraction which is not further purified or otherwise processed is employed as a crude oil-derived feedstock.

The term “feed mixture” refers to the mixture of at least the polymer waste-based feedstock and the crude oil-derived feedstock. The feed mixture may further contain one or more further feed material(s) other than a polymer waste-based feedstock and a crude oil-derived feedstock. In other words, the “further feed material” is neither a polymer waste-based feedstock nor a crude oil-derived feedstock. If two or more polymer waste-based materials (feedstocks) are employed in the feed mixture, these are collectively regarded as the polymer waste feedstock. Similarly, if two or more crude oil-derived materials (feedstocks) are employed in the feed mixture, these are collectively regarded as the crude oil-derived feedstock.

The term “hydrotreating” (which may hereinafter sometimes also be referred to as “hydroprocessing”) refers to a chemical transformation of the polymer waste-based feedstock in the FCC feed hydrotreater in the presence of hydrogen to produce hydrocarbonaceous material. The effluent of the FCC feed hydrotreater will usually contain unreacted hydrogen, water, various gases and other compounds originating from heteroatoms or metals (such as H2S, HCl, HBr, NH3) and, as the case may be, non-reactive components such as carrier gas. Of these, at least gaseous components (and water) are preferably separated as a part of the hydrotreating process. In the hydrotreatment (hydrotreating process), olefins and aromatics are at least partly saturated and heteroatoms are removed. In other words, hydrotreating is the reaction of organic compounds in the presence of (high pressure) hydrogen to remove heteroatoms and/or to alter the degree of saturation of the organic compounds. The resulting material (after separation of gaseous compounds, water, heteroatom-derived material and metal-derived material) consists predominantly of hydrocarbons (molecules consisting of hydrogen atoms and carbon atoms) and may contain residual (non-hydrocarbon) impurities. This resulting material is referred to as “hydrocarbonaceous material” in the present invention.

The hydrotreatment in the present invention is carried out in a FCC feed hydrotreater and it is intrinsic to this kind of FCC feed hydrotreatment reactor (and FCC feed hydrotreatment process) that the hydrotreatment predominantly results in saturation and heteroatom removal whereas (hydro)isomerisation and/or (hydro)cracking occur only as minor side reactions, if any.

The term “FCC feed hydrotreater” refers to a hydrotreatment reactor which is designed to and arranged for pre-treatment of FCC feed in a conventional oil refinery setting. The term “FCC feed hydrotreater” thus implies both the reactor as such as well as the reaction conditions.

The term “hydrocarbonaceous material” refers to a material which predominantly consists of hydrocarbons (i.e. molecules consisting of carbon and hydrogen atoms). Specifically, the “hydrocarbonaceous material” preferably contains at least 95.0 wt. % of carbon (C) and hydrogen (H) atoms, as determined by elemental analysis, relative to the material as a whole. Other components such as oxygen (O), sulphur (S), nitrogen (N) may be present as well, usually in the form of organic molecules. The content of H and C is preferably at least 97.0 wt.-%, at least 98.0 wt.-% or at least 99.0 wt.-%.

The term “distilling” refers to a separation method by evaporation and condensation and encompasses fractionation. Distilling may be carried out under elevated pressure, under ambient pressure and/or under reduced pressure. The result of the distillation (distilling process) is at least one distillate (fraction) and a distillation residue (or distillation bottoms product, i.e. the heaviest fraction). Accordingly, the recovery of step E may be carried out as a distillation or comprising a distillation. Usually, distillation is carried out as fractionation and results in multiple distillate fractions having differing boiling point ranges. These distillate fractions are usually mixtures of multiple compounds and are designated by their starting boiling point and by the end boiling point, such as xx° C.-yy° C., meaning that the fraction starts boiling at or above xx° C. and is fully evaporated at or below yy° C. The distillation bottoms fraction (distillation bottoms product) is usually designated only by its initial boiling point (or starting boiling point) and is recovered without being distilled (i.e. from the bottom of the distillation).

The term “heavy gas oil fraction” or “HGO fraction” which may be recovered in the step E of the method of the present invention refers to a fraction of the product of the hydrotreating step D. As such, the HGO fraction is a fraction of the hydrocarbonaceous material. Further, the HGO fraction is a high-boiling fraction and may be the highest-boiling fraction which is obtained in a distillation of the hydrocarbonaceous material, or, alternatively may be an intermediate fraction (i.e. a distillate fraction). In general, the HGO fraction usually has a high starting boiling point (or initial boiling point). Since the starting boiling point is sometimes difficult to determine, the HGO fraction of the present invention preferably has a 10% boiling point (according to ASTM-D2887; wt.-%) of at least 300° C. In case the HGO fraction is the highest-boiling fraction, the end boiling point of the HGO fraction corresponds to the final boiling point of the hydrocarbonaceous material; in other words, the HGO fraction may be the distillation bottoms fraction. The HGO fraction of the present invention preferably has a 90% boiling point (according to ASTM-D2887; wt.-%) of up to 620° C.

The present invention is based on the finding that co-processing of a polymer waste-based feedstock and a crude-oil derived feedstock in a FCC feed hydrotreater (under FCC feed hydrotreating conditions) is possible and allows preparing a higher-value (upgraded) material from the otherwise difficult to handle polymer waste-based feedstock. Specifically, the co-processing in this specific FCC feed hydrotreater allows integration of the highly diverse and thus difficult polymer waste-based feedstock into conventional petrochemical processes with small effort and costs.

Specifically, the co-processing allows easy integration of varying amounts of recycled material (polymer waste or polymer waste-based material). Various fractions (i.e. boiling point ranges) of the polymer waste-based feedstock can be used since distillation is carried out after hydrotreatment, so that fractionation of a polymer waste-based feedstock, such as a polymer waste-based oil, prior to hydrotreatment in the present invention is usually not necessary. By design, even a conventional FCC feed hydrotreater is suited to handle difficult feeds, such as a crude oil HGO fraction, and thus can handle the (highly contaminated) polymer waste-based feedstock as well.

In addition, when employing a liquefied polymer waste, not only the HGO fraction is obtained in high yield but furthermore a higher share of valuable lower-boiling fractions may be obtained (and fractionated and recovered), such as a diesel fraction, a jet fuel fraction or a gasoline fraction.

Preferably, the crude oil-derived feedstock is a FCC feedstock. Such a feedstock is most suitable in the process since a FCC feed hydrotreater (being usually the first stage of a conventional FCC apparatus) is designed for that kind of feedstock. In particular, the crude oil-derived feedstock preferably comprises at least one crude oil fraction selected from a vacuum gas oil (VGO) fraction, a gas oil (GO) fraction, a heavy gas oil (HGO) fraction, a kerosene fraction, a light gas oil fraction, an atmospheric residue (AR) fraction, a vacuum residue (VR) fraction and a deasphalted oil (DAO) fraction. Among them, it is preferable to employ mainly (at least 50 wt.-%) the higher-boiling fractions, namely a vacuum gas oil (VGO) fraction, a heavy gas oil (HGO) fraction, an atmospheric residue (AR) fraction, a vacuum residue (VR) fraction, and a deasphalted oil (DAO) fraction, whereas the lighter fractions (namely a gas oil (GO) fraction, a kerosene fraction, and a light gas oil fraction) are employed only in addition to the heavier ones. For example, at least 40 wt.-% of the crude oil-derived feedstock boil at a temperature of 370° C. or above (40% distillation temperature according to ASTM-D2887), or at least 45 wt.-% of the crude oil-derived feedstock boil at a temperature of 370° C. or above, preferably at least 50 wt.-%, at least 55 wt.-%, at least 60 wt.-% or at least 65 wt.-%.

Furthermore, the crude oil-derived feedstock may have a 5% boiling point (according to ASTM-D2887; wt.-%) of at least 160° C., preferably at least 170° C., at least 180° C., at least 190° C., or at least 200° C. and/or a 95% boiling point (according to ASTM-D2887; wt.-%) of 630° C. or lower, preferably 610° C. or lower, 590° C. or lower, 570° C. or lower, or 560° C. or lower. The final boiling point (according to ASTM-D2887) of the crude oil-derived feedstock may for example be 650° C. or lower, preferably 630° C. or lower, 620° C. or lower, 610° C. or lower, or 600° C. or lower.

In the present invention, the “final boiling point” (FBP) refers to the 99.5% boiling point and the “initial boiling point” (IBP) refers to the 0.5% boiling point (according to ASTM-D2887; wt.-%).

A heavy gas oil (HGO) fraction (or a distillation bottoms fraction) recovered in step E may have a 10% boiling point (according to ASTM-D2887; wt.-%) of at least 300° C., preferably at least 310° C., at least 320° C., at least 330° C., at least 340° C., at least 345° C., at least 350° C., or at least 355° C. Such a product fraction of the method of the present invention is particularly suited for processing in a conventional downstream cracking process, such as a steam cracking process or particularly a FCC process. Lighter fractions of the hydrocarbonaceous material, which may be obtained as additional (further) products of the method of the present invention may be used directly for other purposes or may be forwarded to other (conventional) petrochemical process, including those mentioned above for the HGO fraction (or distillation bottoms product).

In the present invention, the yield of a heavy fraction boiling at 350° C. or above (if not specified otherwise, boiling points and ranges in the present invention refer to the boiling point or range at normal pressure of 101.324 kPa) may be at least 50 wt.-%, when calculated as the ratio (m_{H}/m_{liq}) between mass of obtained heavy fraction (m_{H}) and total mass of liquid hydrocarbonaceous products (m_{liq}) obtained in step D. The “heavy fraction” is not necessarily a fraction which is recovered in the method of the present invention, but may be a hypothetical fraction which may be obtained e.g. by simulated distillation. Such a high share of high-boiling products means that the FCC feed hydrotreater works under conditions which achieve hydrotreatment but no or little (hydro)cracking. The yield of the heavy fraction may preferably be at least 55 wt.-%, at least 60 wt.-% or at least 65 wt.-%. In this context, the liquid hydrocarbonaceous products refer to (the total sum of) hydrocarbonaceous products in the hydrocarbonaceous material which boiling at or above 25° C. at a pressure of 1013.25 hPa (absolute). As a consequence, the FCC feed hydrotreater produces a large share of products in a boiling point range which is suited for subsequent FCC, which is the usual successor of a FCC hydrotreatment unit in a conventional oil refinery.

Similarly, the yield of a light hydrocarbonaceous fraction (including gaseous products) boiling at 150° C. or below obtained in step D is preferably at most 10.0 wt.-%, when calculated as the ratio (m_{L}/mₕₜ) between mass of obtained light hydrocarbonaceous fraction (m_{L}) and total mass of hydrocarbonaceous products (mₕₜ). The yield may be at most 8.0 wt.-%, at most 6.0 wt.-%, at most 5.0 wt.-%, at most 4.0 wt.-%, at most 3.0 wt.-%, or at most 2.0 wt.-%. A high yield of such (very) light boiling hydrocarbonaceous components in the hydrocarbonaceous material obtained in step D would imply a high degree of cracking occurring in the FCC feed hydrotreater and/or a high share of light-boiling components in the feed mixture. However, one skilled in the art will appreciate that FCC feed hydrotreaters may be operated in different ways depending on what is desired outcome of the process at a given time. The FCC feed hydrotreater may e.g. be operated to reach a constant sulphur content for the FCC feed, to reach a maximum degree of aromatics saturation for the FCC feed, or even to maximize the production of diesel boiling point range products via conversion of the heavier feed molecules.

The FCC feed hydrotreater may, for example, operate at a temperature in the range of from 300-460° C. Suitable operation temperatures are in particular 320° C. or above, preferably 340° C. or above or 360° C. or above and/or 455° C. or below, preferably 450° C. or below, 445° C. or below, 440° C. or below, 435° C. or below, 430° C. or below, 425° C. or below, 420° C. or below, 415° C. or below, or 410° C. or below. Treatment temperatures in this range help ensuring good hydrotreatment efficiency, low cracking tendency and low isomerisation tendency. The good hydrotreatment efficiency particularly results in low amounts of olefins and of heteroatom-containing impurities (in particular sulphur impurities), and lower amounts of aromatic hydrocarbons in the hydrocarbonaceous material, thus causing less problems (such as coking) in downstream processes.

The FCC feed hydrotreater may, for example, operate at a hydrogen partial pressure of at least 10 bar, preferably at least 20 bar, at least 25 bar, at least 30 bar, at least 33 bar, at least 35 bar, at least 38 bar, or at least 40 bar, and/or at most 100 bar, preferably at most 90 bar, at most 80 bar, at most 70 bar, at most 60 bar, at most 55 bar, or at most 50 bar. These ranges are often employed in a conventional FCC feed hydrotreater and help ensuring efficient hydrotreatment. If not specified to the contrary, a pressure value given in the present invention refers to absolute pressure.

The FCC feed hydrotreater may, for example, operate at a liquid hourly space velocity (LHSV, m³ liquid feed per m³ catalyst and per hour) of at most 8.0 h⁻¹, preferably at most 6.0 h⁻¹, at most 4.0 h⁻¹, at most 3.0 h⁻¹, at most 2.0 h⁻¹, at most 1.5 h⁻¹, or at most 1.3 h⁻¹, and/or at least 0.2 h⁻¹, preferably at least 0.4 h⁻¹, at least 0.6 h⁻¹, at least 0.7 h⁻¹, at least 0.8 h⁻¹, at least 0.9 h⁻¹, or at least 1.0 h⁻¹. The FCC feed hydrotreater may, for example, operate at a ratio (H2/HC) between hydrogen (H2) and feed mixture (HC) of at most 800 l/l, preferably at most 600 l/l, at most 500 l/l, at most 350 l/l, or at most 300 l/l; and/or at least 50 l/l, preferably at least 100 l/l, at least 120 l/l, at least 150 l/l, at least 180 l/l, at least 200 l/l, or at least 220 l/l. These conditions similarly facilitate efficient hydrotreatment.

The FCC feed hydrotreater preferably employs a catalyst. The catalyst may be a supported catalyst. The catalyst may, for example, comprise at least one component selected from IUPAC group 6, 8 or 10 of the Periodic Table of Elements. When employing a supported catalyst, the catalyst preferably contains Mo and at least one further transition metal on a support. Examples of such a supported catalyst are a supported NiMo catalyst or a supported CoMo catalyst, or a mixture of both. In a supported catalyst, the support preferably comprises alumina and/or silica. These catalysts are usually employed as sulphided catalysts to ensure that the catalysts are in their active (sulphided) form. Turning the catalysts into their active (sulphided) form may be achieved by sulphiding them in advance (i.e. before starting the hydrotreatment reaction) and/or by adding a sulphur-containing feed (containing sulphur e.g. as an organic or inorganic sulphide). The feed may contain the sulphur from the beginning or a sulphur additive may be admixed to the feed.

In a preferable embodiment, the FCC feed hydrotreater employs a catalyst and the catalyst is a supported NiMo catalyst and the support comprises alumina (NiMo/Al₂O₃) and/or the catalyst is a supported CoMo catalyst and the support comprises alumina (CoMo/Al₂O₃).

Employing a catalyst facilitates ensuring efficient hydrotreatment and helps reducing isomerisation tendency and/or cracking tendency. Particularly the preferred catalysts facilitate reducing isomerisation tendency and/or cracking tendency.

Accordingly, it is preferred that the step D is carried out in a temperature range, at a hydrogen pressure, at a LHSV and/or at a H2/HC ratio as specified above in the presence of a catalyst as specified above, in particular a supported Mo-containing catalyst, such as NiMo/Al₂O₃ and/or CoMo/Al₂O₃.

FCC feed hydrotreaters are typically operated in a manner that enables reaching a specific sulphur content for the FCC feed, and in certain instances to maximize FCC feed aromatics saturation, or to maximize the production of lighter diesel boiling point range products via conversion of the heavier feed molecules. At the same time, utilization of such process conditions also results in saturation of olefins which are more reactive compared to aromatics. As a measure for the efficiency of olefin-saturation conditions, the bromine number reduction rate (BRh/BRf) can be given. That is, in the present invention it is preferable that the FCC feed hydrotreater is adjusted such that the ratio (BRh/BRf) between the bromine number of the hydrocarbonaceous material (BRh) and the bromine number of the feed mixture (BRf) is 0.50 or less, preferably 0.40 or less, 0.30 or less, 0.20 or less, 0.10 or less, 0.07 or less, 0.06 or less 0.05 or less or 0.04 or less.

The method of the present invention may further comprise a step of subjecting at least part of the distillation bottoms product recovered in step E to fluid catalytic cracking (FCC). A co-feed (FCC co-feed), which may e.g. originate from another unit within a conventional oil refinery setting, may be subjected to the FCC process together with (fraction of the) distillation bottoms product. One skilled in the art can appreciate that depending on the exact configuration of an oil refinery, there may be several sources for the aforementioned FCC co-feed material. The suitability of a given FCC co-feed material would depend e.g. on its boiling point range, sulphur content and aromatics content. Suitable FCC co-feed materials could be obtained e.g. from hydrocracking units.

Preferably, the feed mixture contains at most 50 wt.-% of the polymer waste-based feedstock, preferably at most 40 wt.-%, at most 30 wt.-% or at most 25 wt.-%. In other words, the mixing in step C is preferably adjusted such that the feed mixture contains at most 50 wt.-% of the polymer waste-based feedstock, preferably at most 40 wt.-%, at most 30 wt.-% or at most 25 wt.-%. This adjustment may suitably be achieved by simply mixing the desired amount.

In general, the mixing (or blending) (step C) may be carried out in a separate vessel or feed line before the FCC feed hydrotreater or the mixing may be carried out within the FCC feed hydrotreater. Preferably, the polymer waste-based feedstock and the crude oil-derived feedstock are mixed before entering the FCC feed hydrotreater, for example in a feeding tank.

The content ranges of the polymer waste-based feedstock as mentioned above have shown to give good results in the final product. The present invention thus covers a significant mixing range up to high contents of polymer waste-based feedstock. In other words, due to feature combination of the present invention, the method of the present invention is suited for a broad content range of polymer waste-based feedstock in the feed mixture subjected to FCC hydrotreatment. The content of the polymer waste-based feedstock is preferably not higher than 50 wt.-% in order to ensure easy integration into existing processes.

In order to ensure at least some use of recycled material (polymer waste-based feedstock) and thus sustainability, the feed mixture preferably contains at least 0.5 wt.-% of the polymer waste-based feedstock, preferably at least 1.0 wt.-%, at least 1.5 wt.-% or at least 2.0 wt.-%. In other words, the mixing in step C is preferably adjusted such that the feed mixture contains at least 0.5 wt.-% of the polymer waste-based feedstock, preferably at least 1.0 wt.-%, at least 1.5 wt.-% or at least 2.0 wt.-%.

Preferably, the feed mixture contains at least 25 wt.-% of the crude oil-derived feedstock, preferably at least 30 wt.-%, at least 40 wt.-%, at least 50 wt.-%, at least 60 wt.-%, at least 70 wt.-% or at least 75 wt.-%. In other words, the mixing in step C is preferably adjusted such that the feed mixture contains at least 25 wt.-% of the crude oil-derived feedstock, preferably at least 30 wt.-%, at least 40 wt.-%, at least 50 wt.-%, at least 60 wt.-%, at least 70 wt.-% or at least 75 wt.-%.

A minimum content of crude oil-derived feedstock, which is a conventional feedstock in FCC hydrotreater, ensures that the method of the present invention can be easily integrated into existing petrochemical processes. Nevertheless, a high degree of sustainability can be achieved, if desired.

The polymer waste-based feedstock provided in step A may be a polymer waste-based oil. The polymer waste-based feedstock provided in step A may preferably be a polymer waste-based oil, more preferably liquefied polymer waste, for example a polymer waste which has been liquefied by thermal degradation, such as pyrolysis or hydrothermal liquefaction.

The polymer waste-based feedstock provided in step A may be a fraction of polymer waste-based oil, in particular a fraction of liquefied polymer waste. The polymer waste-based feedstock provided in step A may nevertheless be a non-fractionated polymer waste-based oil, since a FCC feed hydrotreater is rather flexible and can handle even such non-fractionated (and even non-processed, i.e. raw or crude) polymer waste-based oil(s).

In the present invention, it is preferable that the polymer waste-based feedstock consists of or comprises a liquefied polymer waste or a fraction thereof, such as liquefied waste plastics (LWP) or a fraction thereof, in particular waste plastics pyrolysis oil (WPPO) or a fraction thereof, or liquefied end-life tires or a fraction thereof, such as end-life tires pyrolysis oil (ELTPO) or a fraction thereof. More generally, the polymer waste-based feedstock may consist of or comprise a thermally liquefied polymer waste, such as a pyrolysis oil feedstock or a fraction thereof, and/or a HTL polymer waste feedstock or a fraction thereof. In this context, a pyrolysis oil feedstock refers to a feedstock derived by pyrolysis of polymer waste, and a HTL (hydrothermal liquefaction) polymer waste feedstock refers to a polymer waste feedstock derived by hydrothermal liquefaction of polymer waste.

Thermal liquefaction, such as pyrolysis and/or hydrothermal liquefaction (each followed by purification, such as separation, if necessary), is a usual method for preparing liquefied polymer waste. Such a material is not easy to handle but the method of the present invention is specifically designed to process even such a challenging feedstock. In particular, pyrolysis and HTL are commonly applied techniques and these kinds of feedstocks are thus readily available at reasonable effort.

The liquefied polymer waste may be pre-treated after liquefaction to provide the polymer waste-based feedstock. Usual pre-treatments are separation (such as gas-liquid separation), distillation or fractionation, solids removal (such as filtration or sedimentation) and extraction techniques, such as liquid-liquid extraction (e.g. using an organic solvent or water, optionally each containing additives such as extraction aids). For example, the pre-treatment may comprise pre-treating a liquefied polymer waste (e.g. crude LWP or a fraction thereof) by contacting the liquefied polymer waste with an aqueous medium having a pH of at least 7 at a temperature of 200° C. or above, followed by liquid-liquid separation and optional further separation and/or purification, to produce the polymer waste-based feedstock.

The pre-treatment may particularly be favourable to lower the impurities content and thus make the polymer waste-based feedstock more suitable for the hydrotreatment step. Favourably, the pre-treatment may already remove some of the impurities (by means other than hydrotreatment) which would otherwise be removed by hydrogenation in the hydrotreatment step, thus lowering the overall consumption of valuable hydrogen and/or increasing the service life of the hydrotreatment equipment.

For example, the polymer waste-based feedstock may have a chlorine content of 5 wt.-ppm or more, such as 10 wt.-ppm or more, 15 wt.-ppm or more, 20 wt.-ppm or more, 50 wt.-ppm or more, or 100 wt.-ppm or more. Suitably, the polymer waste-based feedstock has a chlorine content of 4000 wt.-ppm or less, 3000 wt.-ppm or less, 2000 wt.-ppm or less, 1000 wt.-ppm or less, 500 wt.-ppm or less, 400 wt.-ppm or less, or 200 wt.-ppm or less. In other words, the method of the present invention is applicable to broad impurity ranges and it is not necessary or even desirable to fully remove chlorine (or other) impurities before subjecting the polymer waste-based feedstock to the FCC feed hydrotreatment step.

Polymer waste-based oils, in particular polymer waste-based feedstocks obtained by thermal degradation of polymer waste, often show a high content of olefins and/or aromatics. These compounds may lead to coking in downstream processes. However, the FCC feed hydrotreater of the present invention is capable of handling such challenging feeds and to convert a majority of problematic compounds so as to provide an upgraded material stream which can be used in a large variety of downstream processes.

For example, the polymer waste-based feedstock may have an olefins content of 10 wt.-% or more, 15 wt.-% or more, 20 wt.-% or more, 30 wt.-% or more, 40 wt.-% or more, or 50 wt.-% or more, and/or 85 wt.-% or less, 80 wt.-% or less, 70 wt.-% or less, or 65 wt.-% or less.

In the present invention, the distillation bottoms product (or HGO fraction) may for example have an aromatics content of 10 wt.-% or more, 15 wt.-% or more, 20 wt.-% or more, 25 wt.-% or more, 30 wt.-% or more, or 40 wt.-% or more, and/or 85 wt.-% or less, 80 wt.-% or less, 70 wt.-% or less, or 60 wt.-% or less. Such an aromatics content in the resulting distillation bottoms product (or HGO fraction) may be achieved by an appropriate combination of feedstocks and hydrotreatment conditions. In particular, a preferred feed mixture of the present invention is derived from a rather high-boiling crude oil-derived fraction and thermally liquefied polymer waste, the former of which typically has rather high aromatics content whereas the latter has rather high olefin content. Furthermore, the hydrotreatment conditions in a usual FCC hydrotreater are such that the aromatics content is not decreased very much, and rather olefin hydrogenation occurs.

In the present invention, the distillation bottoms product (or HGO fraction) may for example have a nitrogen content of 100 wt.-ppm or more, 200 wt.-ppm or more, 300 wt.-ppm or more, 400 wt.-ppm or more, 500 wt.-ppm or more, or 600 wt.-ppm or more. Further, the distillation bottoms product (or HGO fraction) may have a nitrogen content of 5000 wt.-ppm or less, 4000 wt.-ppm or less, 3000 wt.-ppm or less, or 2000 wt.-ppm or less. The distillation bottoms product (or HGO fraction) may have a sulphur content of 10 wt.-ppm or more, 20 wt.-ppm or more, 30 wt.-ppm or more, 50 wt.-ppm or more, 100 wt.-ppm or more, 200 wt.-ppm or more, 250 wt.-ppm or more, 300 wt.-ppm or more, 350 wt.-ppm or more, or 400 wt.-ppm or more, and/or may have a sulphur content of 10000 wt.-ppm or less, 6000 wt.-ppm or less, 5000 wt.-ppm or less, 4000 wt.-ppm or less, or 3000 wt.-ppm or less.

In an embodiment, the step A of providing the polymer waste-based feedstock includes a step of thermal degradation (such as pyrolysis or hydrothermal liquefaction) of waste plastics. Thus, a complete method can be provided from (solid) polymer waste to upgraded material. The thermal degradation step may further comprise a work-up stage, such as a separation stage.

The present invention furthermore provides a mixture of hydrocarbons obtainable by the method according to the present invention. The mixture of hydrocarbons may specifically be the distillation bottoms product, an HGO fraction and/or another fraction obtained in the recovery step D.

The present invention furthermore provides a hydrocarbonaceous material obtained in step D of the method according to the present invention. The hydrocarbonaceous material preferably comprises more than 16 wt.-% of a fraction boiling in the range of 150-300° C. and at least 60 wt.-% of a fraction boiling above 370° C.

In the present invention, the olefins content of the distillation bottoms product (or HGO fraction) may for example be 4 wt.-% or less, preferably 3 wt.-% or less. The olefins content of the distillation bottoms product (or HGO fraction) can be estimated from the bromine number and used in the present invention. The distillation bottoms product (or HGO fraction) may for example have a bromine number of 10 g Br/100 g or less, 8 g Br/100 g or less, 6 g Br/100 g or less, 5 g Br/100 g or less, 4 g Br/100 g or less, 3 g Br/100 g or less, 2 g Br/100 g or less, or 1 g Br/100 g or less.

The present invention furthermore provides a use of the mixture of hydrocarbons (or of a hydrocarbonaceous material obtained in step D) as specified above as a raw material in the production of fuel, chemicals and/or polymers, such as polypropylene and/or polyethylene.

For example, a low-to-medium-boiling fraction (e.g. a gasoline fraction, a diesel fraction or a jet fuel fraction) obtained in step D of the method of the present invention may be used as a fuel component either directly or after further work-up, such as polishing. The distillation bottoms product (or HGO fraction) may be forwarded to a usual petrochemical process for high-boiling fractions, such as FCC, or to steam cracking to provide unsaturated hydrocarbons which may be used as a raw material in the production of polymers or other chemicals.

The present invention specifically provides a use of a mixture of hydrocarbons obtained in the method of the present invention as a FCC feedstock, a steam cracking feedstock, a solvent component or a fuel component, such as a diesel component, a gasoline component or a jet fuel component.

The present invention has been described with reference to specific embodiments. Unless specified to the contrary each of these preferred embodiments and each of the ranges of numerical values (of any degree of preference) may be combined with any other embodiment and/or any other ranges of numerical values (of any degree of preference) and each of these combinations shall be encompassed within the disclosure of the present invention.

### Measurement Methods Used in the Present Invention

Unless specified otherwise, the following measurement methods can be applied in the present invention.

In the present invention, the content of F, Cl, and Br may be determined in accordance with ASTM-D7359. The content of iodine (I) may be determined by XRF (X-ray fluorescence) spectroscopy. Sulphur (S) content may be determined in accordance with ASTM-D7039. Nitrogen (N) content may be determined in accordance with ASTM-D4629 for samples containing 0.3-100 mg/kg N and having boiling point ranges of approximately 50-400° C. and room temperature viscosities of 0.2-10 mm²/s. For other types of petroleum samples with N content of 100 mg/kg or more, ASTM-D5762 can be used. Depending on the characteristics of the sample, the aromatics content may be determined according to EN12916, or alternatively according to ASTM-D2549.

For methods not mentioned above, the methods used in the Examples may be employed. In the context of the present invention, standards (e.g. ASTM or EN-ISO) refer to the latest version available on Nov. 30, 2020, unless specified otherwise.

### EXAMPLES

In the following, the present invention will be described by reference to Examples. It is to be understood that Examples are for illustration purposes and shall not limit the scope of the invention, which is defined by the claims. Nevertheless, numerical values and ranges (of e.g. contents of compounds or impurities) disclosed in the Examples may be combined with numerical values and/or ranges disclosed in the general description above to give new numerical ranges.

### Example 1

A WPPO (waste plastics pyrolysis oil) was prepared by pyrolysis of collected waste plastics and employed as a polymer waste-based feedstock without further purification or fractionation. The feedstock was a mixture of the products of two pyrolysis processes in a weight ratio of 1:1, of which the first product had a 5-95% boiling range of from about 95-477° C. and the second product had a 5-95% boiling range of from about 66-475° C. A conventional fossil feedstock being a high-boiling crude oil fraction (a conventional fossil FCC feed hydrotreater feedstock; IBP: 94.3° C.; FBP: 580.2° C.; density measured at 15° C.: 914 kg/m³, density measured at 50° C.: 889 kg/m³) was used as a crude oil-derived feedstock. A feed mixture was prepared by blending the WPPO and the fossil feed so that the total content of WPPO in the feed mixture was 10 wt.-% and the total content of the fossil feed in the feed mixture was 90 wt.-%.

The feed mixture was subjected to hydrotreatment in a laboratory scale continuous flow hydrotreating reactor operating at FCC feed hydrotreater conditions. Hydrotreatment conditions were set to 398° C. and 48 bar hydrogen partial pressure (with no added inert gas).

After the hydrotreatment, the liquid product was recovered by gas-liquid separation and the total liquid product was distilled to four different fractions, namely light naphtha (IBP-150° C.), light gas oil (150-300° C.), gas oil (300-370° C.), and heavy gas oil (370° C.-FBP). The distillation yields and the analysis results of different products are shown in Tables 1 to 4. Note that the catalyst (CoMo/Al₂O₃) of the FCC hydrotreater was at the end of its service life and was sulphided at the start of the experiment. Consequently, the sulphur content of the products may be higher compared to what would be obtainable with a less deactivated catalyst.

### Comparative Example 1

The hydrotreatment and distillation of Example 1 was repeated, except for using 100% of the fossil feedstock as a reference sample. The results are shown in Tables 1 to 4.

TABLE 1
Fractionation yields

| | Comparative Example 1 | | Example 1 | |
|---|---|---|---|---|
| Fraction | Mass g | Yield % | Mass g | Yield % |
| IBP-150° C. | 24.5 | 0.38 | 118.5 | 1.82 |
| 150-300° C. | 992.7 | 15.25 | 1187 | 18.24 |
| 300-370° C. | 572.4 | 8.8 | 577.1 | 8.87 |
| 370° C.-FBP | 4918.3 | 75.57 | 4578.6 | 70.35 |

TABLE 2
Detailed analysis of light gas oi fraction (150-300° C.)

| | | | Comparative | |
|---|---|---|---|---|
| | | | Example 1 | Example 1 |
| ENISO12185 | density 15° C. | kg/m3 | 847.8 | 836 |
| ASTMD7689 | cloud point | ° C. | −52.8 | −49 |
| EN12916 | arom-LC¹⁾ | vol-% | 43.3 | 36 |
| ASTMD4629 | nitrogen | mg/kg | 110 | — |
| ASTMD5762 | nitrogen | mg/kg | — | 120 |
| ENISO4264 | cetane index | | 35.6 | 40.1 |
| ASTMD7039 | sulphur | mg/kg | 38.8 | 48.2 |

¹⁾arom-LC means total aromatics content measured by liquid chromatography according to EN12916 (specified for diesel fraction)

TABLE 3
Detailed analysis of gas oil fraction (300-370° C.)

| | | | Comparative | |
|---|---|---|---|---|
| | | | Example 1 | Example 1 |
| ENISO12185 | density 50° C. | kg/m3 | 857.5 | — |
| ENISO12185 | density 15° C. | kg/m3 | — | 872.3 |
| ASTMD7689 | cloud point | ° C. | — | −4.8 |
| ENISO3104 | viscosity 40° C. | mm2/s | 5.61 | 6.104 |
| EN12916 | arom-LC | wt-% | 46.3 | 37.9 |
| ASTMD4629 | nitrogen | mg/kg | 540 | |
| ASTMD5762 | nitrogen | mg/kg | — | 630 |
| ASTMD7039 | Sulfur | mg/kg | 350 | 560 |

TABLE 4
Detailed analysis of heavy gas oi fraction (370° C.-FBP)

| | | | Comparative | |
|---|---|---|---|---|
| | | | Example 1 | Example 1 |
| ENISO12185 | density 50° C. | kg/m3 | 882.1 | 882.9 |
| ISO2977 | aniline point | ° C. | 88.5 | 91.3 |
| ENISO10370 | carbon residue | wt-% | 0.14 | 0.22 |
| ASTMD2549 | aromatic | wt-% | 41.9 | 39.5 |
| ASTMD2549 | non-aromatic | wt-% | 58.1 | 60.2 |
| ASTMD2549 | yield | % | 99.9 | 99.99 |
| ASTMD4629 | nitrogen | mg/kg | 1100 | — |
| ASTMD5762 | nitrogen | mg/kg | — | 1500 |
| ASTMD7039 | sulphur | mg/kg | 1680 | 2450 |

When compared against the results obtained with WPPO (Comparative Example 1), the addition of WPPO into the FCC feed hydrotreater feed LWP (Example 1) did not induce surprising negative changes in product quality that could be attributed to WPPO. One skilled in the art will also appreciate that depending on the manner in which the experiments were performed, other factors such as catalyst deactivation, process conditions, experiment duration and the order in which the feeds were tested may influence the quality of the products. Physical properties such as density, viscosity and cloud point were influenced in a limited manner due to the WPPO addition. This can be attributed to the more paraffinic nature of the hydroprocessed WPPO when compared against the conventional FCC hydrotreater feed and the products derived from it. This was also reflected in the aromatics content of all the analysed product fractions—the fractions that were produced in Example 1 had lower aromatics content, and would therefore be more attractive than the products of Comparative Example 1 for applications where low aromatics content is desired. Such applications comprise fluid catalytic cracking, steam cracking and utilization as diesel fuel.

### Example 2

The procedure of Example 1 was repeated, except for recovering a jet fuel fraction (IBP-240° C.) in addition to heavier fractions, including the HGO as a bottoms fraction. The results are shown in Table 5 below.

TABLE 5
Detailed analysis of jet fuel fraction

| | | | Comparative | |
|---|---|---|---|---|
| | | | Example 1 | Example 2 |
| ENISO12185 | Density | kg/m3 | 839.2 | 832.2 |
| ASTMD7689 | Cloud point | | | −64.2 |
| ENISO3104 | Viscosity 40° C. | mm2/s | — | 1.223 |
| ENISO3104 | Viscosity −20° C. | mm2/s | 3.947 | 3.907 |
| ENISO3104 | Viscosity −40° C. | mm2/s | 8.003 | 7.935 |
| EN12916 | Arom - LC | wt-% | 46.4 | 45.1 |
| EN12916 | Arom - LC | vol-% | 43.9 | 42.2 |
| ASTMD4629 | Nitrogen | mg/l | 19 | — |
| ASTMD4629 | Nitrogen | mg/kg | — | 33 |
| ASTMD7039 | Sulfur (XRF method) | mg/kg | 6.9 | 5.8 |
| IP529 | Freezing point | ° C. | −56.1 | −59 |
| ASTMD5001 | Bocle | mm | 0.62 | 0.57 |

As can be seen from Table 5 above, the jet fuel fraction is well-suited as a jet fuel component. In particular, the Bocle lubricity reaches a value which is conventionally difficult to obtain with sustainable procedures.

1. A method for upgrading polymer waste-based material, the method comprising:
providing a polymer waste-based feedstock (step A);
providing a crude oil-derived feedstock (step B);
mixing the polymer waste-based feedstock, and the crude oil-derived feedstock to provide a feed mixture (step C);
hydrotreating the feed mixture in a FCC feed hydrotreater to provide a hydrocarbonaceous material (step D); and
recovering at least a distillate product and a distillation bottoms product from the hydrocarbonaceous material (step E).

2. The method according to claim 1, wherein the crude oil-derived feedstock contains at least one crude oil fraction selected from at least one or more of: a vacuum gas oil (VGO) fraction, a gas oil (GO) fraction, a heavy gas oil (HGO) fraction, a kerosene fraction, a light gas oil fraction, an atmospheric residue (AR) fraction, a vacuum residue (VR fraction), and/or a deasphalted oil (DAO) fraction.

3. The method according to claim 1, wherein the distillation bottoms product recovered in step E has a 10% boiling point (according to ASTM-D2887) of at least one or more of: at least 300° C., and/or at least 310° C., and/or at least 320° C., and/or at least 330° C., and/or at least 340° C., and/or at least 345° C., and/or at least 350° C., and/or at least 355° C.

4. The method according to claim 1, wherein a yield of a heavy fraction boiling at 350° C. or above obtained in step D is at least one or more of at least 50 wt.-%, when calculated as a ratio (m_{H}/m_{liq}) between mass of obtained heavy fraction (m_{H}) and total mass of liquid hydrocarbonaceous products (m_{liq}), and/or at least 55 wt.-%, and/or at least 60 wt.-%, and/or at least 65 wt.-%.

5. The method according to claim 1, wherein a yield of a light hydrocarbonaceous fraction boiling at 150° C. or below obtained in step D is at least one or more of at most 10.0 wt.-%, when calculated as a ratio (m_{L}/mₕₜ) between mass of obtained light fraction (m_{L}) and total mass of hydrocarbonaceous products (mₕₜ), and/or at most 8.0 wt.-%, and/or at most 6.0 wt.-%, and/or at most 5.0 wt.-%, and/or at most 4.0 wt.-%, and/or at most 3.0 wt.-%, and/or at most 2.0 wt.-%.

6. The method according to claim 1, wherein the FCC feed hydrotreater operates at a temperature in a range of from 300-460° C.

7. The method according to claim 1, wherein:
the FCC feed hydrotreater operates at a hydrogen partial pressure of at least one or more of: at least 10 bar, and/or at least 20 bar, and/or at least 25 bar, and/or at least 30 bar, and/or at least 33 bar, and/or at least 35 bar, and/or at least 38 bar, and/or at least 40 bar, and/or;
wherein the FCC feed hydrotreater operates at a hydrogen partial pressure of at least one or more of: at most 100 bar, and/or at most 90 bar, and/or at most 80 bar, and/or at most 70 bar, and/or at most 60 bar, and/or at most 55 bar, and/or at most 50 bar.

8. The method according to claim 1, wherein the FCC feed hydrotreater employs a catalyst and the catalyst is a supported catalyst, and the catalyst comprises:
at least one component selected from IUPAC group 6, 8 or 10 of the Periodic Table of Elements.

9. The method according to claim 1, wherein the FCC feed hydrotreater employs a catalyst and the catalyst is a supported catalyst containing Mo and at least one further transition metal on a support, and/or a supported NiMo catalyst and/or a supported CoMo catalyst, wherein the support contains alumina and/or silica.

10. The method according to claim 1, wherein the FCC feed hydrotreater employs a catalyst and the catalyst is a supported CoMo catalyst, and the support contains alumina (CoMo/Al₂O₃), and/or the catalyst is a supported NiMo catalyst and the support contains alumina (NiMo/Al₂O₃).

11. The method according to claim 1, wherein the FCC feed hydrotreater works under olefin-saturation conditions.

12. The method according to claim 1, wherein the polymer waste-based feedstock provided in step A is a fraction of liquefied polymer waste.

13. The method according to claim 1, wherein the feed mixture contains at least one or more of: at most 50 wt.-% of the polymer waste-based feedstock, and/or at most 40 wt.-%, and/or at most 30 wt.-% and/or at most 25 wt.-%, and/or the feed mixture contains at least one or more of: at least 0.5 wt.-% of the polymer waste-based feedstock, and/or at least 1.0 wt.-%, and/or at least 1.5 wt.-% and/or at least 2.0 wt.-%.

14. The method according to claim 1, wherein the feed mixture contains at least one or more of: at least 25 wt.-% of the crude oil-derived feedstock, and/or at least 30 wt.-%, and/or at least 40 wt.-%, and/or at least 50 wt.-%, and/or at least 60 wt.-%, and/or at least 70 wt.-% and/or at least 75 wt.-%.

15. The method according to claim 1, wherein the polymer waste-based feedstock is a pyrolysis oil feedstock derived from waste plastics (waste plastics pyrolysis oil; WPPO) and/or from end-life tires (end-life tires pyrolysis oil; ELTPO), or a fraction thereof, and/or a feedstock derived from hydrothermal liquefaction of waste plastics and/or of end-life tires, or a fraction thereof.

16. The method according to claim 1, wherein the step A of providing the polymer waste-based feedstock comprises:
a step of thermal degradation (such as pyrolysis or hydrothermal liquefaction) of polymer waste.

17. A mixture of hydrocarbons obtained by the method according to claim 1.

18. A hydrocarbonaceous material obtainable in step D of the method according to claim 1, wherein the hydrocarbonaceous material comprises:
more than 16 wt.-% of a fraction boiling in a range of 150-300° C. and at least 60 wt.-% of a fraction boiling above 370° C.

19. A method according to claim 1, comprising:
producing a mixture of hydrocarbons from the hydroicarbonaceous material as a raw material in a production of fuel, chemicals and/or polymers, and/or polypropylene and/or polyethylene.

20. A method according to claim 1, wherein the step C mixing comprises:
mixing a further feed material with the polymer waste-based feedstock and the crude oil-derived feedstock.
